(19) United States
(12) Patent Application Publication
(10) Pub. No.: US 2024/0397926 A1
(43) Pub. Date: Dec. 5, 2024

(54) MOLE / VOLE KILLER & LAWN REPAIR TOOL

(71) Applicant: RICHARD WARREN ATKINSON, Pageland, SC (US)

(72) Inventor: RICHARD WARREN ATKINSON, Pageland, SC (US)

(21) Appl. No.: 18/204,829

(22) Filed: Jun. 1, 2023

(51) Int. Cl. A01M 17/00; A01B 1/24

(52) U.S. Cl. CPC A01M 17/00; A01B 1/24

(57) ABSTRACT

A tool for exterminating subterranean burrowing animals, such as moles and voles, said tool includes a half inch thick square steel base plate that is about is about 4.5 inches by 4.5 inches, and a steel handle that is about 44-48 inches long is perpendicularly welded to a top central surface of the base plate. The handle has a grip covering an upper end of the handle and extends down the handle at least 12 inches. The ratio of handle length to base surface area is about 2.17 to 2:37. The invented tool weighs 9.5 plus/minus 0.5 lbs.

### BACKGROUND OF THE INVENTION

### 1. Field of the Invention

The invention is a tool for exterminating subterranean burrowing animals, such as moles and voles. Additionally, the tool is used to repair damage caused by the underground burrowing, more specifically the mounds and the tunnels. The tool can be used on existing lawns, which would be damaged by tractors and/or vehicles. The tool is furthermore invented to be ergonomically suitable for use by people limited to relatively light weights, and need not utilize any chemicals, including water, soap or oils, nor electricity or fuels.

### 2. Background

Kleisath in his U.S. Pat. No. 5,548,921 (Kleisath'921) teaches a system and method for gassing an animal, such as a gopher, within an underground burrow. The system comprises a probe (2) having a shaft (6) with first and second ends (8, 10) and a tip (14) on the first end. In his method a shallow hole (54) is formed in the ground with the tip of the probe to locate the burrow and dry solid chlorine material is introduced into the burrow. Water is then poured into the hole onto the dry chlorine material to generate chlorine gas and the hole is closed to seal the gaseous poison within the burrow, thereby allowing the gaseous poison to expand throughout the burrow and gas the animal. Since chlorine gas is heavier than air, the gas will naturally follow the gopher to the deepest recesses of its underground dwelling, killing the gopher without endangering agriculture or other life above the ground

According to Kleisath'921 one known method of killing gophers or moles is to introduce a poisonous gas through one of the entrance or exit holes into the gopher burrow. The gas either kills the gopher or drives the gopher out through another hole where it can be killed by conventional means, e.g. a gun or club. Kleisath'921 notes that it is important to ensure that the poisonous gas does not escape back through the entrance hole, thereby causing damage to surrounding agriculture or possibly being inhaled by the user. According to Kleisath, to prevent this from occurring, the prior art has mainly focused on pressurized cartridges that form poisonous gases, such as chloro-cyanic gas, through chemical combustion and then distribute these pressurized gases into the gopher burrows.

In U.S. Pat. No. 7,617,630 B2 Larry Allan Holmes (Holmes'630) teaches a method and apparatus for exterminating subterranean burrowing air-breathing animals which burrow subterranean tunnels having burrowed hole openings at ground level. The Holmes'630 apparatus includes an elongate arm having a base end and an opposite distal end, a frame mounted to a vehicle, the base end of the arm mounted to the frame, a selectively activable actuator mounted so as to cooperate between the frame and the arm, at least one reservoir of a lethal substance, conduits cooperating between the reservoirs and the arm for carrying the lethal substance to deliver the lethal substance from the distal end of the arm into the burrow hole openings, wherein positioning the arm and delivering the lethal substance is remotely activable from within the vehicle.

U.S. Pat. No. 9,848,593 B2 to Joseph Asciutto (Asciutto'593) teaches a method for the extermination of burrowing vermin. The method employs a smoke generating fluid formed of castor oil or castor oil in a mix with secondary components. The fluid is heated to a smoking temperature and the smoke is mixed with a pressurized airflow to communicate the smoke to the tunnels occupied by the burrowing vermin to remove them, and to leave a residue from the smoke which exudes an order deterring the re-occupancy of the tunnels.

Commercial tamps advertised as suitable for yard work, such as sold by Tractor Supply Co., have a 10″×10″ base, a weight of 20 lbs., and a 44-inch handle. Free falling from 2 ft the tamper generates 3.2 psi.

### SUMMARY OF THE INVENTION

The invention is a tool for exterminating subterranean burrowing animals, such as moles and voles in a defined area of land, which nominally is a lawn or garden. The tool produces enough compaction, on the order of 25±10 pounds-force, which is enough force to level one or all access points to a tunnel. Following leveling of one or all access points, the tool produces enough compaction to incrementally collapse the ground above the tunnel until it is level, employing a focused force that is sufficient to level an entire surface length of the tunnel back into the tunnel, therein repairing the defined area of land and exterminating the subterranean burrowing animals that created the tunnels and mounds.

A user of the invented tool has the option of exterminating the subterranean burrowing animal, or just driving the burrowing animal from the defined area of land.

A first aspect of the invention is that chemicals, including water, soap or oils; nor poisonous gases, aren't used, so there are no unwanted side effects to plants, people and wildlife.

A second aspect of the invention is that it typically weighs less than about ten pounds, light enough to be used on existing lawns, which would be damaged by tractors and/or vehicles. Nominally, about ten pounds is ergonomically suitable for use by people limited to relatively light weights; and

A final object of the invention is that it has tamping and hoeing applications to help maintain a yard, fencing, cement, tiling, and planting.

### BRIEF DESCRIPTION OF THE DRAWINGS

The foregoing invention will become readily apparent by referring to the following detailed description and the appended drawings in which:

FIG. 1 is a side view of the invented MOLE/VOLE KILLER & LAWN REPAIR TOOL;

FIG. 2 is an overhead isometric view of the invention shown in FIG. 1;

FIG. 3 is a partial side view of the handle that illustrates that a top end of the handle is hollow, and it is capped with a plug having an arced head;

FIG. 4 a side view of the plug with the arced head;

FIG. 5 a side view of the grip 30 shown in FIG. 1, wherein the grip 30 increases the diameter of handle, and provides improved friction and ergonomic advantages for a user;

FIG. 6 a cross-sectional side view of a relatively shallow subterranean tunnel created by a burrowing animal, such as a mole or a goffer or a vole, wherein the tunnel is visible on the surface as an elongate mound that, with the invented tool can be tamped level;

FIG. 7 is a cross-sectional side view of the elongate mound after it has been tamped, where in the illustrated case, the burrowing animal was present when the tunnel was tamped, and the burrowing animal was instantly flattened when the ground was leveled;

FIG. 8 is a force table that, wherein several scenarios are calculated as to the force that is generated using an invented tool that weighs about only about nine pounds is raised to two feet;

FIG. 9 is a dimension table that includes an illustrative size and weight of the invented tool; and

FIG. 10 is a diagrammatic view of the invented tool elevated H feet over mound and the semicircular elongate ridge housing the tunnel.

### DETAILED DESCRIPTION OF THE INVENTION

The invention is a tool for exterminating subterranean underground burrowing animals, and in particular moles and voles, and usually in a defined area of land, which nominally is a lawn or garden. The invented tool is also useful for repairing the lawn or garden.

The invention has a base having a bottom surface area that is about of about 20.25 sq. inches, wherein each side is about 4.5 inches. The weight of the invented tool is about 9.0 to 10.0 lbs., with a resting PSI of about one-half pound per square inch (0.49 psi). The handle is 44-48 inches long, with a handle length to surface area ratio of 2.17 to 2:37. The instant invention free falling from a height of 2 feet would generate 15.8 psi. In contrast, the prior art tamper has a much higher weight of 20 lbs., but a resting PSI of about one fifth of a pound per square inch (0.20 psi). The prior art tamper has a handle length to surface area ratio of about 0.44. The prior art tamper free falling from the height of 2 feet would generate only 3.2 psi, which is about a fifth of the instant invention.

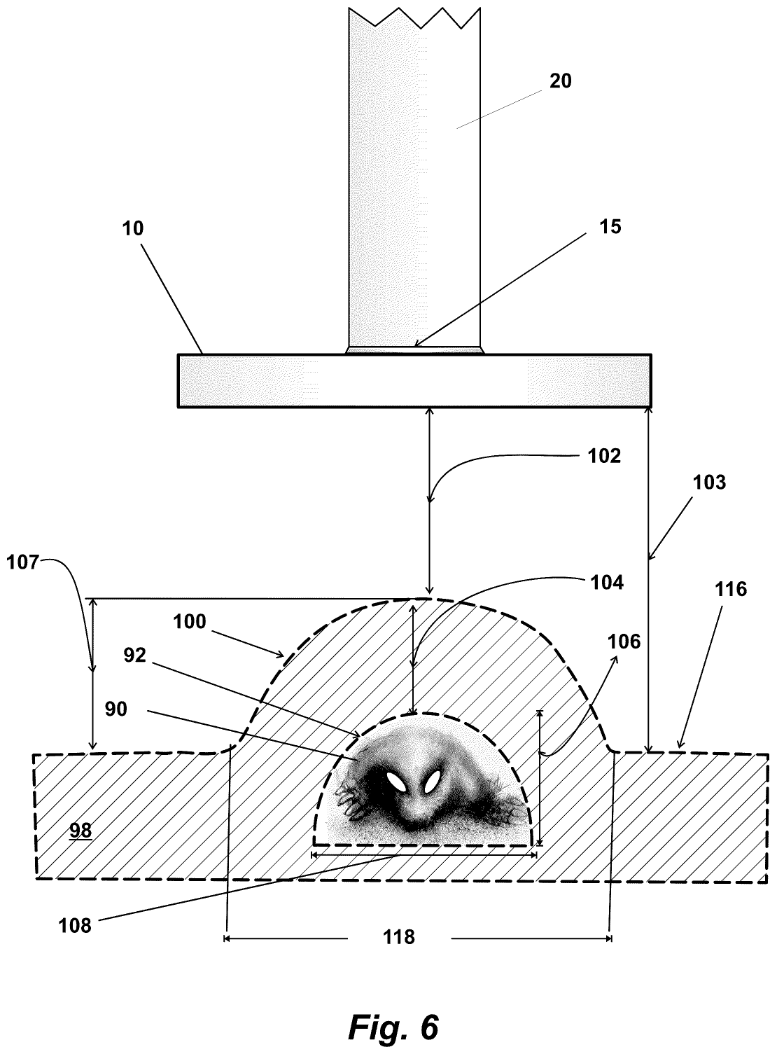

Moles and voles are burrowing animals and as relatively small rodents, they can burrow inches below the surface of the ground. The moles and voles dig down from the ground surface creating a mound, and then continue burrowing below the ground surface creating a tunnel, wherein the burrowing produces a semicircular elongate ridge on the ground surface, as shown in the cross-sectional view in FIG. 6. The semicircular elongate ridge has a height that is typically about 1.5 inches above the level ground. The semicircular elongate ridge as a ground level cross-sectional diameter of about 3.7 inches. The length of the semicircular elongate ridge is substantially the same as the length of the tunnel. If the depth of burrowing increases, the height of the semicircular elongate ridge decreases, but the cross-sectional diameter will be substantially unchanged. As noted, the cross-sectional shape of a typical tunnel and the semicircular elongate ridge are shown in FIG. 6. The floor is about flat. In contrast, the mound, wherein the earth is piled up, tends to nearly round, and more conical in shape.

The invented tool enables the user to flatten the semicircular elongate ridge and the mound, such that the ground surface is compacted, therein returned to about level. The mound is typically higher than the ridge, as the burrowing is downward, and dirt is looser and piled higher, but the mole/vole can be anywhere in the tunnel(s), as in the case of moles in particular that is where the food is and, potentially, other moles in season.

The user's strategy can affect whether the invented tool is used to exterminate or to evict moles and voles from the defined area of land.

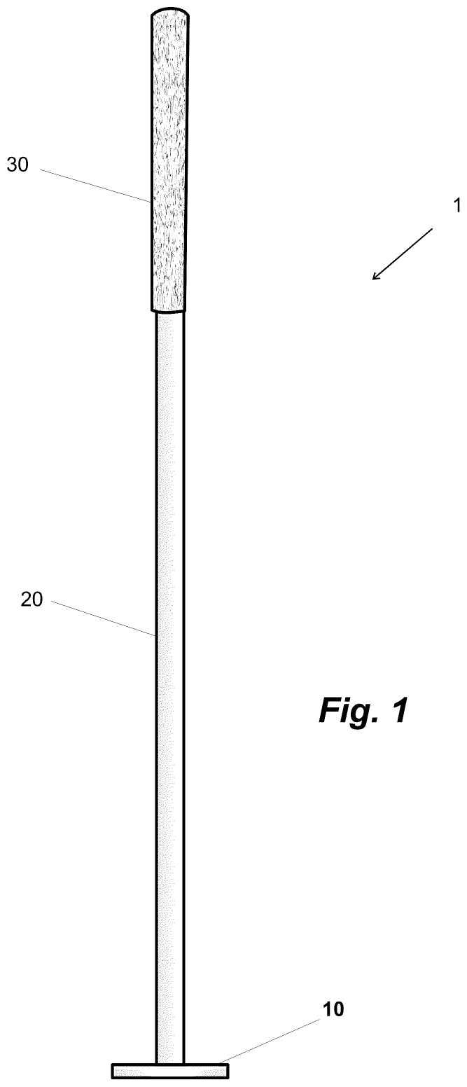

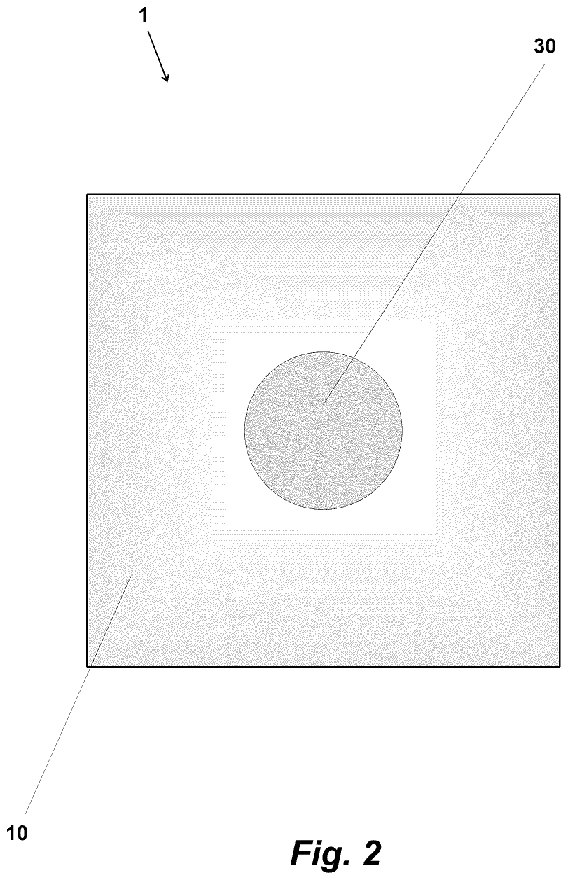

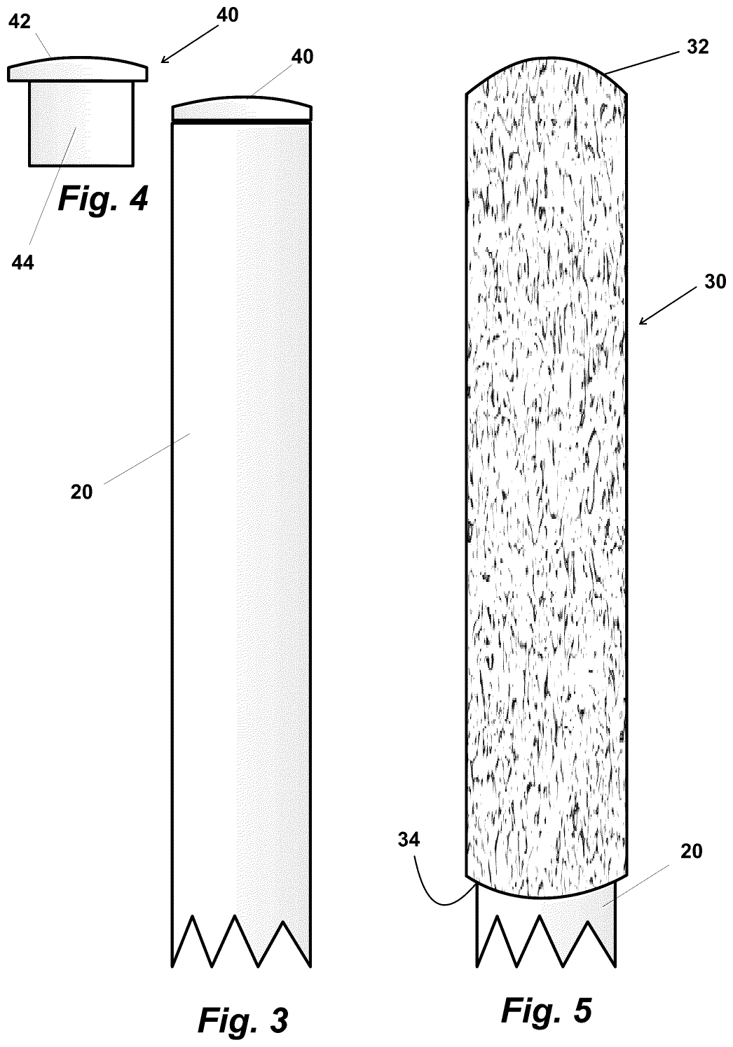

The mole/vole killer & lawn repair tool, as shown in FIG. 1, is ergonomically suitable for use by people who have a ten-pound weight limitation, yet with it, the user is capable of generating enough force to collapse the semicircular elongate ridge and the mound back to level ground. The illustrated tool 1 weighs about nine pounds (4.1 kilograms).

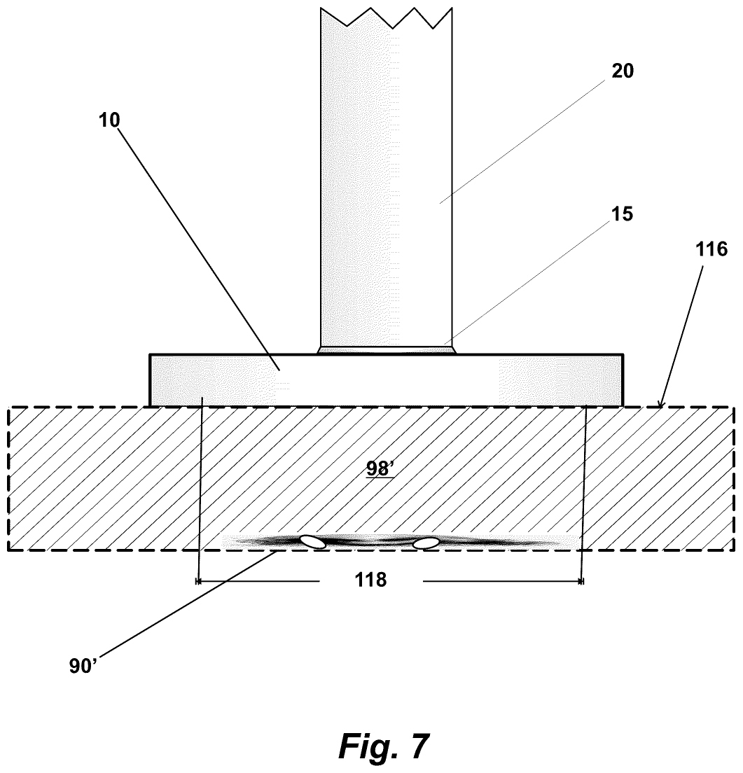

The base plate 10 is 4.5″×4.5″ square steel plate and is 0.5″ thick, and weighs about 2.9 lbs. A hollow 1.05″ ID carbon steel (Schedule 40) pipe 20 having a 1.315″ OD is welded to the top center of the base plate 10. The carbon steel (Schedule 40) pipe 20 functions as a 4 ft handle. The weld line 15 is illustrated in FIG. 6 and FIG. 7.

An upper portion of the handle 20 is fitted with a grip 30. The illustrated grip 30 is about 11±3 inches long with a circumference of 4.7±1 inches. Similarly, the grip 30 shown in FIG. 5 is about 8 inches long. The top end of the handle 20 has a plug 40 with an arced head 42 and an insert 44. The insert has an OD that is the ID of pipe 20. The illustrated arced head 42 has a sectional length that is about equal to the OD of pipe. The plug 40 is preferably made of an impact resistant plastic, such as HDPE, Nylon, an acrylic polymer, ABS, et cetera. The plug provides the grip some protection upon impact of the top end 22 of the handle 20 against a hard surface, disperses edge forces from cutting a user's hand and other body parts, and provides cushioning for the closed end of the grip. The grip 30 has a curved end 32 and an ID 34 that is stretched to the OD of the pipe.

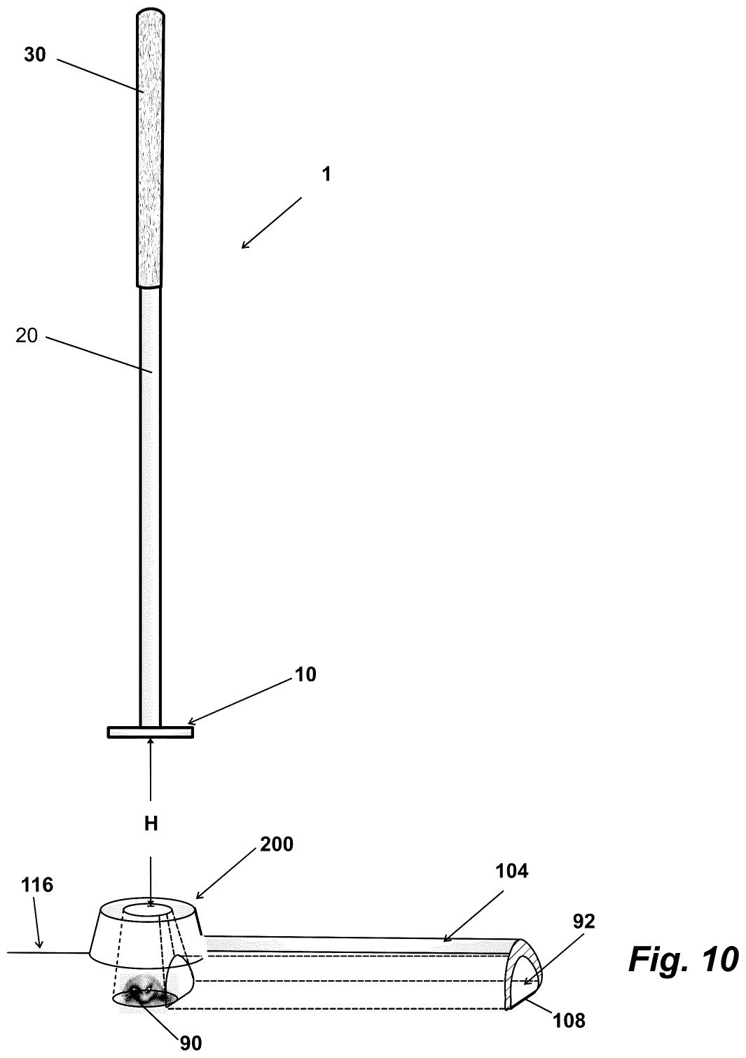

The mole/vole killer & lawn repair tool is used to flatten the semicircular elongate ridge and the mound, such that the ground surface is compacted, therein returned to about level. The user imparts potential energy to the tool by elevating the plate over the mound. In FIG. 10, a bottom of the plate 10 is suspended over the mound 200 a height of H. Collapsing at least one mound is typically a first step, whether extermination or eviction is the goal. As shown in the Table in FIG. 9, at a height of one foot, and the user applies no force, there will an average force of 144 lbs. This assumes a compaction of 1.5 inches, which is about the height of the semicircular elongate ridge. This may not be high enough, and the user's natural tendency is to push down, if for no other reason to control the tool. Raising the tool to 2 feet, and applying a downward force of 10 lbs. increases the average force to of 304 lbs., which is an average of 15 psi. By contrast a tamping tool that weighs more (20 lbs.) with a 10″×10″ plate has an average force of 562 lbs., but only 5.6 average psi. The instant invention is lighter and yet produces 4.2 times the psi with an applied downward force of 10 lbs.

The base 10 dimensions as shown in FIG. 9 are 4.5″×4.5″. This length assures that the base 10 spans the ridge width 118 shown in FIG. 6, which is about 3.6″ width. The ground beyond the ridge is already compacted. The 4.5″×4.5″ base provides about a half inch of latitude on both sides of the ridge 100.

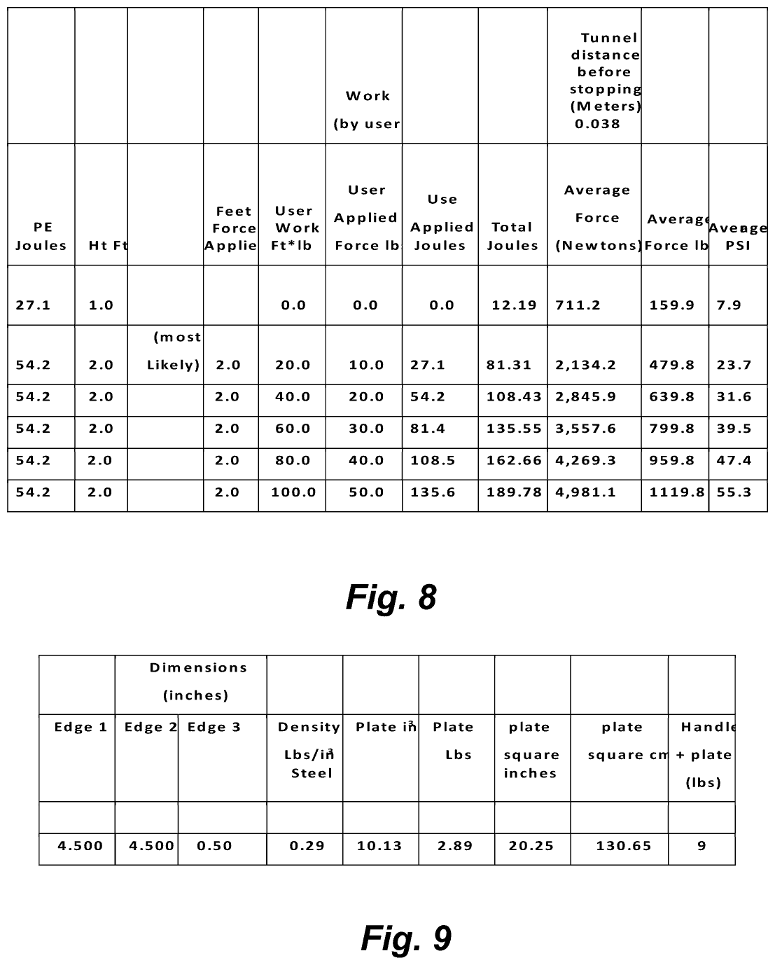

The calculations shown in FIG. 8 utilize American dimensions that are converted into SI units, and then back to American dimensions. For example, the elevated tool has potential energy (PE). PE is mass (kilograms)×the gravity constant (9.8 m/sec2)×height (meters). One pound is 0.4536 Kg. 9 pounds is 4.0823 Kg. One foot=0.3048 meters. The PE at 1 foot is 12.19 Joules. At two feet, the PE is 24.39 Joules. PE and work are both measured in Joules. When the tool is used it is usually pushed downward, and this action is work. If the user force is 10 pounds-force and it is pushed 2 foot, then the foot pounds is 20 ft*pounds-force. 10 lbs.-F is 44.48 Newtons, 2 ft is 0.6096 meters, so 20 foot-pounds force is 27.12 Joules. The user's work and the PE added together is 81.31 Joules

From FIG. 6, we know that the ridge height 107 is about 1.5 inches above the ground level 116. The height 104 to the top of tunnel is about one inch. 1.5 inches is 0.0381 meters, so compacting the ridge will dissipate the 81.31 Joules over 0.0381 meters, and the Joules divided by 0.0381 meters yields an average force of 2,134.18 Newtons. 1 Newton equals 0.2248 pounds-force. So 2, 134.18 Newton is 479.78 pound force. In terms of psi, the plate has a lower surface area of 20.25 sq in, so the psi is 479.78/20.25, which is 23.69 psi. The PE and User's work is about equivalent at a drop height of 2 ft and applied user lbs. force of 20.

The illustrated tunnel 92 for the mole 90 in FIG. 6 (in cross-section of earth 98) has a height 106 of 1.23 inches and a width 108 of 2.1 inches. The top of tunnel is below the surface about 1 inch, as shown by line 104. Plate 10 is currently only 3.3 inches (see line 103) from the ground 118.

Viewing FIG. 8 again. The average weight of a 1-year child is about 20 lbs. At a plate 10 raised to about 2 ft and an applied force of 20 pounds-force, the average psi increases to 31.6 psi, and the average force 639.78 lbs. Both 479.78 lbs. and 639.78 lbs. are more than enough force to collapse a 3.6″ width portion of the elongate ridge 100, as shown in FIG. 6 and FIG. 7, to where the ground is level. The width of the mound 200 is also typically about the same at the mouth of the mole hole, and the dirt is looser.

Returning whether extermination or eviction is the goal, if extermination is desired, then the next step is to compact all the mounds in the defined area. The final step is to compact the elongate ridge 100, such that compaction is to ground level.

If eviction is the goal, then after compacting one mound, start compacting any elongate ridges leading away from the compacted one mound, in essence driving the mole/vole out. If it is apparent that there is only one elongate ridge, and it connects to another mound, do not compact the connecting mound until the next day, giving the mole/vole nocturnal cover to move out, hopefully to another defined area.

The invented tool is useful in lawn repair. For example, following installation of a water pipe, an electrical conduit or a cable, fill dirt is never fully tamped therein creating a ridge, that after time settles, becoming a trough. Installation of a tombstone takes years before the dirt/grass is level. Golf divots remain for weeks. In pastoral areas dried horse and cow manure can be pulverized and spread. The ground can be leveled and tamped when laying pavers and bricks, so that they will not settle and shift over time. In gardening applications, the invented tool can be used as a hoe to create a trough between rows. In fencing and cement the invented tool is more effective than a tamper, as it is lighter, but still produces much higher psi, and higher compaction. The compaction typically is on the order of 25±10 pounds-force.

Finally, any numerical parameters set forth in the specification and attached claims are approximations (for example, by using the term “about”) that may vary depending upon the desired properties sought to be obtained by the present invention. At the very least, and not as an attempt to limit the application of the doctrine of equivalents to the scope of the claims, each numerical parameter should at least be construed in light of the number of significant digits and by applying ordinary rounding.

What is claimed is:

1. A tool for exterminating subterranean burrowing animals, such as moles and voles said tool comprising:
a base plate has a bottom surface area of about 20.25 sq inches, wherein each side is about 4.5 inches;
a handle that is about 44-48 inches long; wherein a base end of the handle is perpendicularly welded to a top central surface of the base plate;
a total weight of said tool that is about 9.5±0.5 lbs.
a grip on the handle, said grip covering an upper end of the handle and extending several inches down the handle;
wherein the bottom surface area of the tool has a resting pounds per square inch of about one half pound per square inch; and
a ratio of handle length to base surface area of about 2.17 to 2:37.

2. The tool according to claim 1, wherein the handle is a carbon steel (Schedule 40) pipe h, with an inside diameter of about 1.05″ ID and an outside diameter of about 1.32″.

3. The tool according to claim 1, wherein the base plate is made of steel, and is about 0.5 inches thick.

4. The tool according to claim 1, wherein the upper end of the handle is fitted with a plug having an arced head and an insert with an OD that that is comparable to the ID of the handle.

5. The tool according to claim 4, wherein the plug is comprised of an impact resistant plastic.

6. The tool according to claim 1, wherein said tool is ergonomically suitable for use by people who have a ten pound weight limitation, yet with it, the user is capable of generating enough force to collapse a semicircular elongate ridge and a mound to a level surface.

7. A tool for exterminating a subterranean burrowing animal, such as mole and vole, wherein if the user lifts the tool about 2 ft and applies 20±10 pounds-force downward, said tool generating a psi of 25±10 on a bottom surface of the base, which is a total average force of 304 total average pounds of force, therein collapsing a mound or a 4.5 inch length of ridge; which causes substantially instantaneous death of the subterranean burrowing animal, if present.

8. A strategy for using a tool for exterminating a subterranean burrowing animal, such as a mole and a voles, wherein said tool comprises:
a base plate has a bottom surface area of about 20.25 sq inches, wherein each side is about 4.5 inches;
a handle that is about 44-48 inches long; wherein a base end of the handle is perpendicularly welded to a top central surface of the base plate;
a total weight of said tool that is about 9.5±0.5 lbs.;
a grip on the handle, said grip covering an upper end of the handle and extending several inches down the handle;
wherein the bottom surface area of the tool has a resting pounds per square inch of about one-half pound per square inch;
a ratio of handle length to base surface area of about 2.17 to 2:37; and
wherein in a first step of extermination, all the mounds in the defined area are compacted; and in the final step all of the elongate ridges are compacted to ground level.
